(19) United States
(12) Patent Application Publication
(10) Pub. No.: US 2002/0093574 A1
(43) Pub. Date: Jul. 18, 2002

(54) Digital camera

(75) Inventors: Taizou Aoki, Itami-Shi (JP); Shinya Nara, Sakai-Shi (JP); Akira Fukada, Osaka-Shi (JP); Masahito Niikawa, Sakai-Shi (JP)

Correspondence Address: SIDLEY AUSTIN BROWN & WOOD LLP, 717 NORTH HARWOOD, SUITE 3400, DALLAS, TX, 75201, US

(73) Assignee: MINOLTA CO., LTD.

(21) Appl. No.: 10/041,897

(22) Filed: Jan. 7, 2002

(30) Foreign Application Priority Data
Jan. 12, 2001 (JP) 2001-004728

(51) Int. Cl. H04N 5/76

(52) U.S. Cl. 348/231; 348/233

(57) ABSTRACT

A digital camera (1) comprises an operational guide element (93) for providing a guide about an operational procedure while displaying a menu on a monitor (21). A user makes a predetermined operation in accordance with the operational guide element (93), and data is copied to a RAM (113) from a memory card (40A). In accordance with an instruction for changing card made by the operational guide element (93), the user removes the memory card (40A) and inserts a memory card (40B) into the same card slot (41), and thereafter makes a predetermined operation in accordance with the operational guide element (93), whereby the data temporarily recorded in the RAM (113) is transferred to the memory card (40B).

This application is based on application No. 2001-004728 filed in Japan, the contents of which are hereby incorporated by reference.

### BACKGROUND OF THE INVENTION

1. Field of the Invention

The present invention relates to a digital camera. More specifically, the present invention relates to an art which enables transfer of data between recording media mounted to a card slot.

2. Description of the Background Art

Conventionally, digital cameras have been used as peripheral devices of personal computer (PC). Therefore, handling of images photographed by a digital camera is essentially predicated on use of a PC.

However, the rapid proliferation of digital camera in recent years increases the opportunities of using digital cameras by users who are not familiar with PC, which has intensified the request for handling photographed images without starting up a PC every time.

Image data photographed by a digital camera can be distributed to a third party, in addition to being printed.

A possible distribution method is to copy an image recorded on a memory card to other recording medium and distribute the other recording medium. Alternatively, if the digital camera has a communication function, it is possible to transmit the data to the party on the other end over telephone lines.

Furthermore, a method of copying an image on a memory card to other memory card includes the methods as follows.

The first method is realized by a digital camera equipped with a plurality of card slots, in which a predetermined copying operation is executed in the condition that both of an original memory card and a target memory card are mounted.

The second method is realized by a digital camera equipped with a built-in flash memory for recording, the method including the steps of copying data to the built-in flash memory from a memory card on which data is recorded, replacing the card with other card, switching the operational menu, and copying the data to the memory card from the built-in flash memory.

According to the second preferred embodiment, data copying between memory cards can be enabled even in the case of a digital camera equipped with only one card slot.

In the above-described first method, however, in the case where one of the card slots is occupied with a card other than a memory card (for example, network card) that has been inserted therein, it is impossible to carry out copying. The method of removing other memory card every time data is copied between memory cards is also troublesome.

Also, in the second method, two-step operation of copying from the memory card to the built-in flash memory and copying from the built-in flash memory to the memory card is required, so that a troublesome operation is required.

### SUMMARY OF THE INVENTION

A digital camera according to the present invention comprises a slot to which a recording medium can be mounted; a memory; an operational guide for providing a guide about an operational procedure for executing a data processing including a first transferring process for transferring data recorded on a recording medium mounted to the slot to the memory and a second transferring process for transferring data recorded in the memory to a recording medium mounted to the slot; an operational member which is operable by an operator; and a controller for executing the data processing in response to an operation to the operational member in accordance with a guide provided by the operational guide.

According to the present invention, data copying between recording media is enabled by a simple operation.

In one aspect of the present invention, the operational guide guides to change the recording medium in the slot after completion of the first transferring process.

As a result of this, it is possible to prevent the user from forgetting to change the recording medium.

In another aspect of the present invention, the operational guide gives a warning if an instruction for starting the second transferring process is made by the operational member after completion of the first transferring process and in the condition that a recording medium within the slot has not been changed.

As a result of this, an operational error by the user can be prevented.

Then, it is an object of the present invention to provide a digital camera which enables easy data copy between recording media without avoiding the necessity of other computer such as PC even in digital cameras in which the number of available slots is limited.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a front view of a digital camera according to a preferred embodiment of the present invention.;

FIG. 2 is a rear view of the digital camera;

FIG. 3 is a side view of the digital camera;

FIG. 4 is a schematic view showing an inside structure of the digital camera;

FIG. 5 is a block diagram showing a functional configuration of the digital camera;

FIG. 6 is a block diagram showing a main functional structure regarding a copy function of a memory card;

FIG. 7 is a flowchart showing a copy processing between memory cards;

FIGS. 8A to 8B are views showing a menu displayed on a monitor by an operational guide element; and

FIGS. 9A to 9D are views showing screen transition displayed on the monitor in carrying out copying operation between memory cards.

### DESCRIPTION OF THE PREFERRED EMBODIMENTS

In the following, a preferred embodiment of the present invention will be explained with reference to the drawings.

<Configuration of Digital Camera>

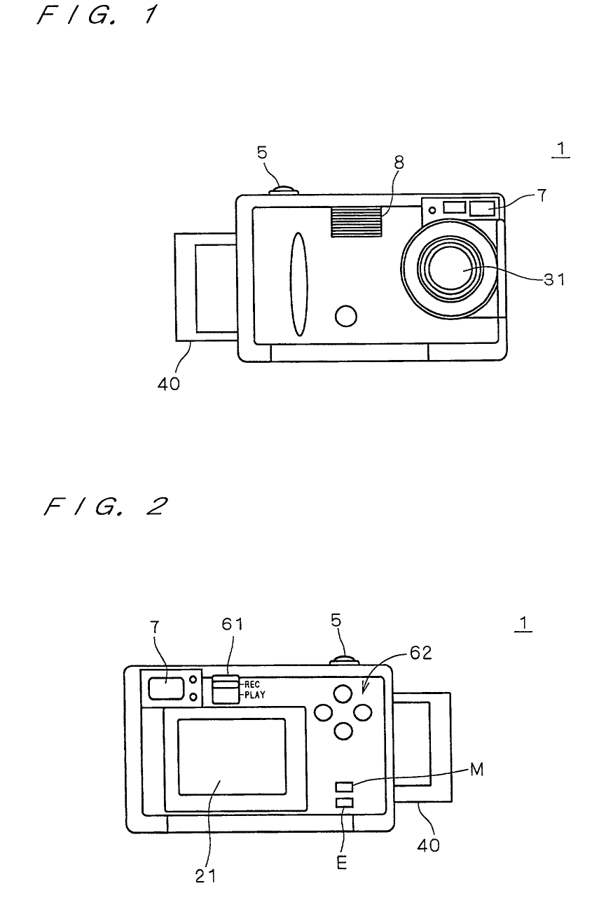

FIGS. 1 to 3 are views showing an appearance of a digital camera according to a preferred embodiment of the present invention, where FIG. 1 is a front view, FIG. 2 is a rear view and FIG. 3 is a side view of the digital camera 1. FIGS. 1 and 2 are illustrated so as to aid the understanding of the state where a memory card 40 is mounted, while FIG. 3 does not illustrate a memory card.

As shown in FIGS. 1 to 3, on the front face of the digital camera 1 are provided a lens unit 31 for taking an image of a subject and a flash 8 for emitting flash toward the subject, whereas on the rear face of the digital camera 1 are provided a monitor 21 having a liquid crystal display of the pixel display type for displaying a photographed image or a live view image, a changeover slide switch 61 for allowing changeover between a photographing mode and a regenerating mode, a four-way key 62 for changing a displayed image and changing a variety of setting conditions, a menu key M for switching the monitor 21 to a menu screen, and an execution key E for confirming a result of selection in the menu.

Furthermore, in the upper part is provide an optical finder 7 for viewing an imaging range, and on the top face is provided a shutter button (release button) 5 which is to be pressed down for photographing a subject. Furthermore, as shown in FIG. 3, on the side face of the digital camera 1 is provided a card slot 41 to which the memory card 40 (see FIG. 1) is to be mounted.

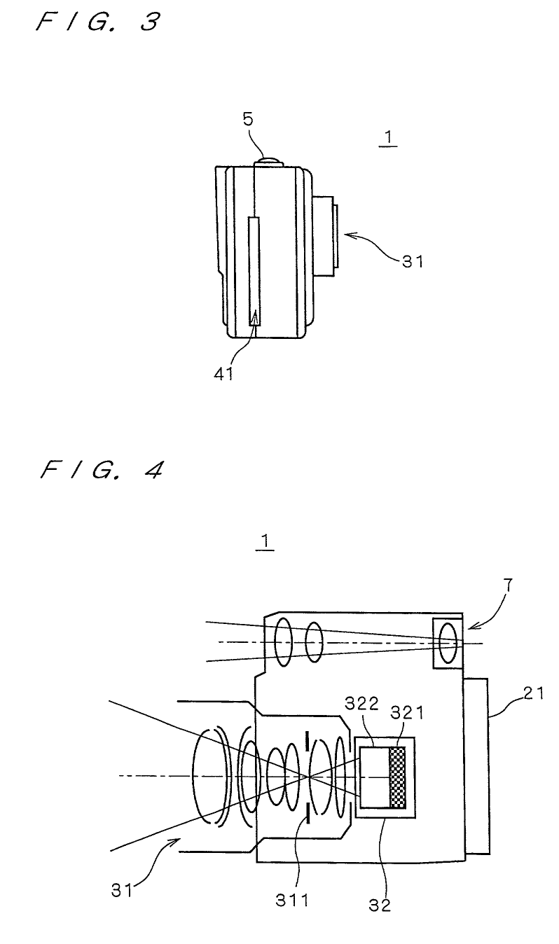

FIG. 4 is a schematic view showing an inside structure with regard to the lens unit 31 and the finder 7 of the digital camera 1. The lens unit 31 consists of various types of lenses and a diaphragm 311 for performing light control, and an image pickup section 32 consists of an image pickup sensor 321 in which an image of a subject is formed by the lens unit 31, and an optical low-pass filter arranged on the front face of the optical axis of the image pickup sensor 321 for reducing moiré.

The image pickup sensor 321 is configured by a CCD area sensor of all pixel reading type which has a plurality of pixels within a plane perpendicular to the optical axis (image pickup surface). On the image pickup surface side of this image pickup sensor 321, primary color transparent filters of R(red), G(green) and B(blue) are bonded in a checkered pattern for each pixel, and each pixel acquires stimulation values of the incident light via the lens unit 31 for the respective color components.

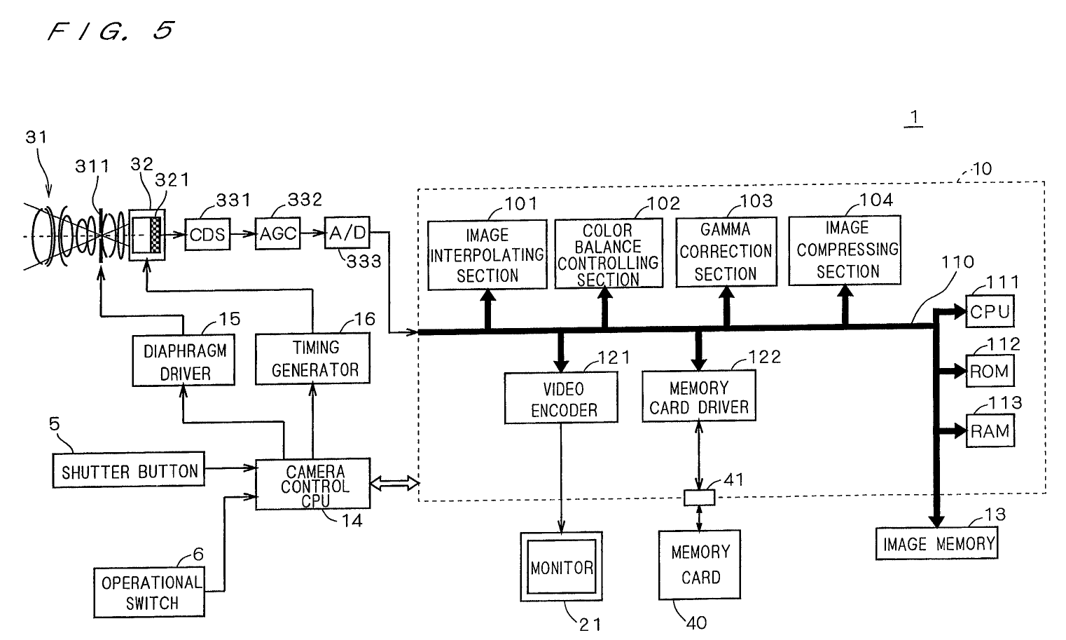

Next, a functional configuration of the digital camera will be explained. FIG. 5 is a block diagram showing a functional configuration of the digital camera.

An image signal acquired in the image pickup section 32 is led to an image processing section 10 via a correlated double sampling (CDS) section 331, an auto gain controlling section (AGC) 332 and an A/D converter 333.

In addition, for controlling each of mechanical parts of the digital camera 1 at the time of photographing, a camera control CPU 14 is provided, which camera control CPU 14 sends a control signal to a diaphragm driver 15 and a timing generator 16.

That is, the diaphragm driver 15 adjusts a diameter of the diaphragm by driving the diaphragm 311 on the basis of a control signal from the camera control CPU 14, and the timing generator 16 controls a starting timing and an ending timing of accumulation of the image pickup sensor 321 on the basis of a control signal from the camera control CPU 14.

Furthermore, the camera control CPU 14 is connected to the shutter button 5, the changeover slide switch 61, the four-way key 62 and the like. In this specification, operational switches other than the shutter button 5, including the changeover slide switch 61 and the four-way key 62 are generally referred to as an “operational switch 6”. Consequently, a photographing timing is inputted to the camera control CPU 14 by means of the shutter button 5, a variety of setting conditions and operation mode and the like are inputted to the camera control CPU 14 by means of the operational switch 6, and these are linked with each other via a communication between the CPU 14 and a CPU 111.

On the other hand, the image processing section 10 for performing various types of processings on an image data which is a digitalized image signal is implemented by, for example, an IC (integrated circuit) of one chip, and has, as a configuration for performing image processing, an image interpolating section 101 for interpolating a value of a pixel with values of peripheral pixels, a color balance controlling section 102 for performing white balance correction, a gamma correcting section 103 for performing nonlinear correction in accordance with the output appliance and an image compressing section 104 for compressing image data that has been processed. The configuration as described above deliver data in relation to a bus line 110 to which the CPU 111 for performing various operations, a ROM 112 storing a basic program and a RAM 113 which is to be a work space are connected. In the image compressing section 104, also expanding process of compressed image data is performed. Each of these hard circuits and the CPU 14 connected to the bus line 110 are controlled in accordance with a controlling program of the CPU 111 stored in the ROM 112.

Furthermore, to the bus line 110 are connected a video encoder 121 for displaying an image on the monitor 21, a memory card driver 122 for recording compressed image data onto the memory card 40 and an image memory 13 for temporarily recording image data that has been acquired by photographing.

The video encoder 121 encodes image data to data of the NTSC system or the PAL system, to cause the monitor 21 to display a preview of the image.

The memory card driver 122 is a part which delivers data in relation to a memory card, and when an instruction for recording image data is made by a user, image data within the image memory 13 is recorded on the memory card 40 via the card slot 41 after being compressed by the image compressing section 104. To the contrary, when an instruction for reading out image data from the memory card 40 is made, the image data is read out from the memory card 40 by the memory card driver 122 and the image data is recorded on the image memory 13 after being subjected to expanding process in the image compressing section 104. In this way, the image data thus read out can be displayed on the monitor 21.

It is to be noted that the memory card 40 may be a recording medium using a magnetic disc or a magneto-optic disc without being limited to a recording medium utilizing a semiconductor memory.

The CPU 111, ROM 112 and RAM 113 in the image processing section 10 are configurations for controlling various operations of the digital camera 1, and settings of photographing conditions or image displaying operations and the like are performed by the CPU 111 to execute operations in the RAM 113 as a work space in accordance with the basic program stored in the ROM 112.

<Copying Between Memory Cards>

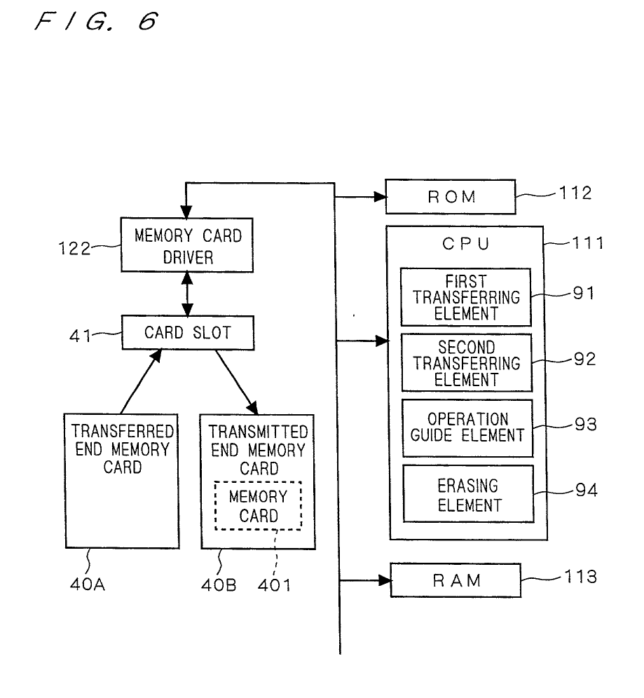

Next, a copying function between memory cards will be explained. FIG. 6 is a view showing a principal configuration part relating to a copying function between memory cards extracted from the block configuration view of the digital camera 1 shown in FIG. 5.

In addition to the basic program as described above, the ROM 112 stores a variety of software for realizing the copying function between memory cards. That is, the ROM 112 stores programs for causing the respective hard circuit, operational member and driving member in the camera to function as a first transferring element 91, a second transferring element 92, an operation guide element 93 and an erasing element 94 under the control of the CPU 111. Though illustrated in the CPU 111 in FIG. 6 for convenience, actually, the first transferring element 91, the second transferring element 92, the operation guide element 93 and the erasing element 94 are functions realized by using each hard circuit etc. in addition to the CPU 111 as described above.

The first transferring element 91 is means for reading data recorded on the memory card 40 mounted to the card slot 41 to copy it to the RAM 113.

To the contrary, the second transferring element 92 is means for copying data which is temporarily copied in the RAM 113 to the memory card 40 mounted to the card slot 41.

The first transferring element 91 and the second transferring element 92 can be made to execute separately by a predetermined operation using the operational switch 6. That is, the operator operates the operational switch 6 to cause the first transferring element 91 to operate so as to copy data in the memory card 40 into the RAM 113, and after changing the memory card 40 inserted in the card slot 41, the operator operates the operational switch 6 again to cause the second transferring element 92 to operate so as to copy the data stored in the RAM 113 to the memory card 40. Although copying between memory cards can be executed by separate operations as described above, in the present preferred embodiment, data copying between memory cards is enabled in a series of operations according to the operation guide element 93 as will be described later.

The operation guide element 93 is means for indicating an operational procedure in a manner that is easy to understand by a user in executing copying operation between memory cards. The operation guide element 93 is configured to display an operation indicating message and the like on the monitor 21 so as to indicate the operational procedure to the user in visible form.

Although the operation guide element 93 is explained as means for indicating copying operation between memory cards in the present preferred embodiment, the operation guide element 93 has means for indicating an operational procedure to a user also for the other functions possessed by the digital camera 1.

Furthermore, the operation guide element 93 also includes a part for making an instruction for changing the memory card 40 in executing copying operation between memory cars. That is, it makes an instruction for changing the memory card mounted to the card slot 41, in the case where data that has been copied to the RAM 113 from the transferring end memory card (hereinafter, referred to as transferring end memory card 40A) is copied to the transferred end memory card (hereinafter, referred to as transferred end memory card 40B) again. In addition, the image memory 13 may be used in place of or in combination with the RAM 113.

The erasing element 94 is means for erasing the data that is temporarily stored in the RAM 113 when copying operation between memory cars is executed.

Furthermore, as shown in FIG. 2. the changeover slide switch 61 which is one of the operational switch 6 allows changeover between a photographing mode “REC” and a regeneration mode “PLAY”. The photographing mode is a mode for photographing a subject, and the regeneration mode is a mode for displaying the taken image on the monitor 21. Then, a transferring mode for executing copying of data between memory cards is operable in the state that the changeover slide switch 61 is switched to the regeneration mode “PLAY”.

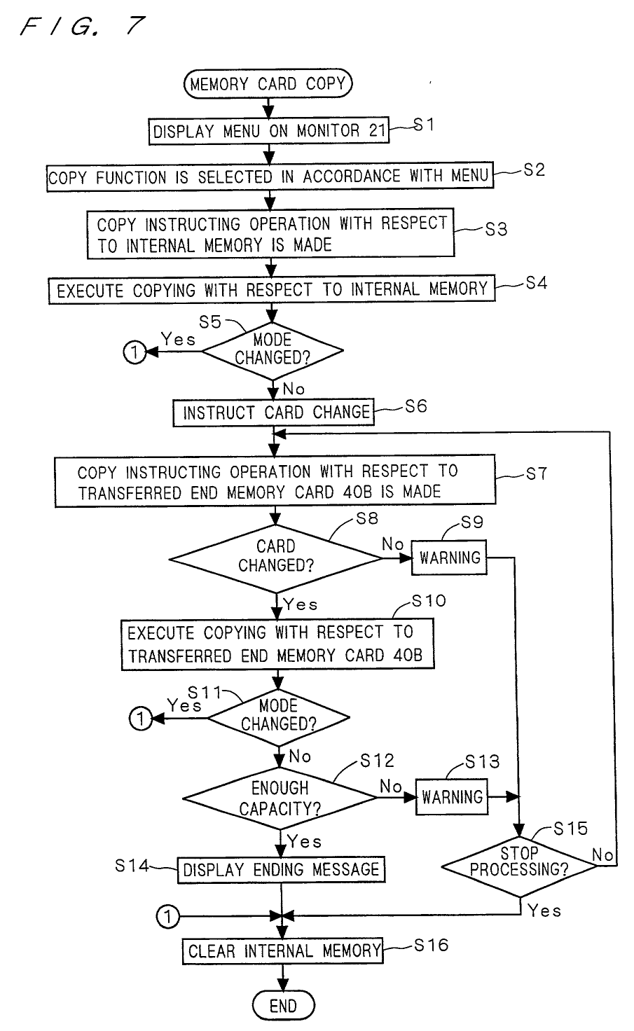

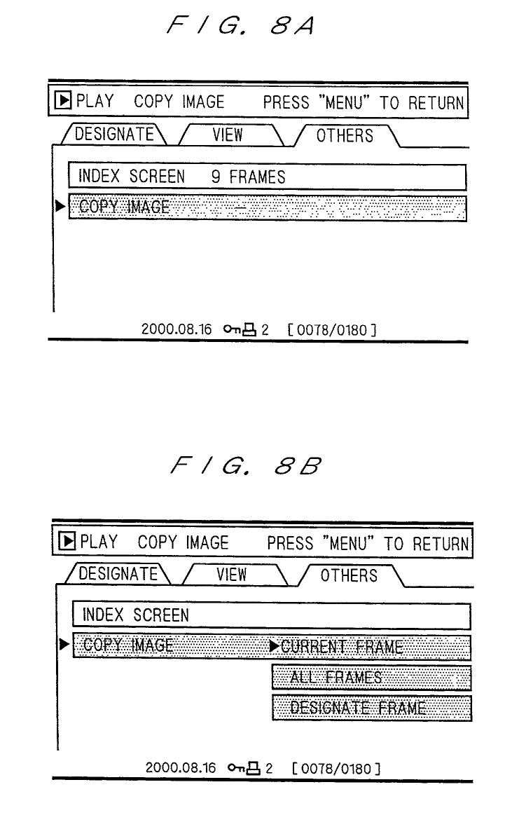

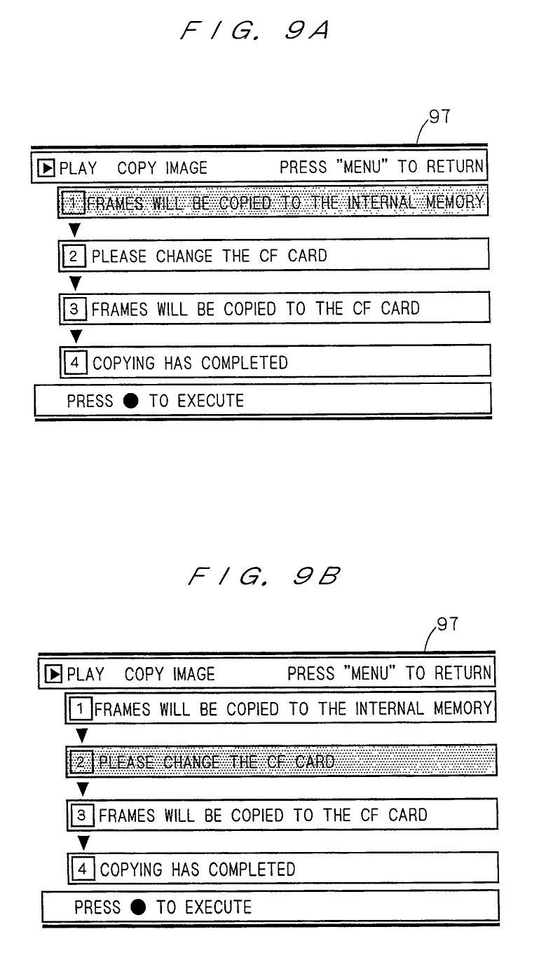

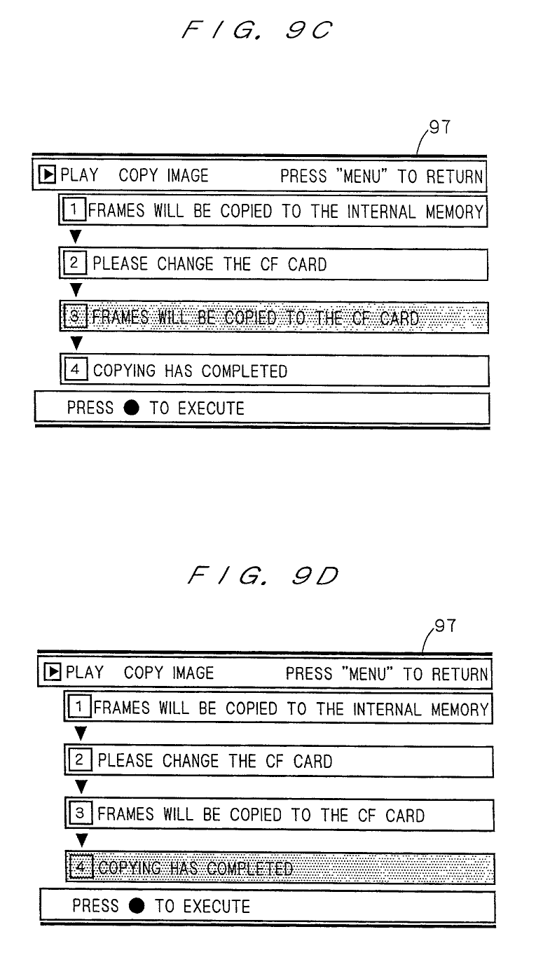

Next, the operation of the copying function will be explained by using the flowchart of FIG. 7 and the screen transition views shown in FIGS. 8A to 8B and 9A to 9D.

It is to be assumed that the user has prepared the transferring end memory card 40A on which data is recorded and the transferred end memory card 40B to which the data recorded on the transferring end memory card 40A is to be copied.

After switching the changeover slide switch 61 to the regeneration mode “PLAY”, the user presses the menu key M to display a menu screen on the monitor 21. Concretely, in response to the operation of the user, the CPU 111 loads a program for causing the monitor 21 to function as the operation guide element 93 from the ROM 112 and executed the program. In this way, the menu screen is displayed on the monitor 21 (step S1).

A menu screen displayed on the monitor 21 in this state is shown in FIG. 8A. The menu screen consists of several pages which are changeable by selection of tab by operating the four-way key 62, each page displaying an executable function and the like.

Then, the user operates the operational switch 6 to select a menu of “COPY IMAGE”. In the drawing shows the state in which the selected “COPY IMAGE” is active.

Furthermore, in the state that the “COPY IMAGE” menu is selected, by making a predetermined operation using the operational switch 6, a sub menu is displayed as shown in FIG. 8B. The sub menu consists of three menus of “CURRENT FRAME”, “ALL FRAMES” and “DESIGNATE FRAME”. If the “CURRENT FRAME” is selected, the regenerated image displayed on the monitor before the menu key M is selected is copied. If the “ALL FRAMES” is selected, all the data in the memory card 40A is copied. If the “DESIGNATE FRAME” is selected, a predetermined menu is displayed and copying is executed after an image to be copied has been selected.

In this context, the case where the “ALL FRAMES” is selected for executing the copying operation will be exemplified. It is to be noted that the effect that can be obtained by executing the copying function according to the present preferred embodiment does not change even when the “CURRENT FRAME” or “DESIGNATE FRAME” is selected.

By selecting the “ALL FRAMES”, an all frame copying function is selected (step S2). Then, as shown in FIG. 9A, a guide menu 97 for copying function is displayed. The guide menu 97 displays four processing procedures of “(1) FRAMES WILL BE COPIED TO THE INTERNAL MEMORY.”, “(2) PLEASE CHANGE THE CF CARD.”, “(3) FRAMES WILL BE COPIED TO THE CF CARD.” and “(4) COPYING HAS COMPLETED.” In the initial state, the “(1) FRAMES WILL BE COPIED TO THE INTERNAL MEMORY.” is highlighted. By displaying the menu in visible manner as described above, improvement of operability is achieved.

In this context, the memory card 40 of the present preferred embodiment is implemented by a compact flash card. The CF card indicated in the guide menu 97 means a compact flash card.

In the state that the “(1) FRAMES WILL BE COPIED TO THE INTERNAL MEMORY.” is highlighted, the user inserts the transferring end memory card 40A into the card slot 41. In the case where the transferring end memory card 40A has already been inserted, this operation is not necessary.

Then, as the user presses the execution key E in the operational switch 6 to instruct “EXECUTION” (step S3), the first transferring element 91 comes into work to sequentially transfer the data recorded on the transferring end memory card 40A to the RAM 113 (step S4). In this case, since the “ALL FRAMES” is selected, all the data in the transferring end memory card 40A is transferred to the RAM 113.

After the data on the transferring end memory card 40A has been transferred to the RAM 113 by the first transferring element 91, whether or not a mode change has been made is determined (step S5). Concretely, whether or not the changeover slide switch 61 has been changed to the photographing mode “REC” is determined. If the mode is not changed, as shown in FIG. 9B, the guide menu 97 displayed on the monitor 21 transits to the state that the “(2) PLEASE CHANGE THE CF CARD.” is highlighted. In this manner, an instruction for changing the card is made by the operation guide element 93 (step S6). The process in the case where it is determined that the mode has changed will be explained later.

The user removes the transferring end memory card 40A from the card slot 41 and inserts the transferred end memory card 40B in accordance with the instruction for changing the card. Then, in the state that the “(2) PLEASE CHANGE THE CF CARD.” is highlighted in the guide menu 97, the user presses the execution key E in the operational key 6 to instruct “EXECUTION”. As a result of these operations, a copy instructing operation with respect to the transferred end memory card 40B is made (step S7).

As the copy instructing operation with respect to the transferred end memory card 40B is made, the operation guide element 93 checks whether the card has been changed (step S8). Concretely, the operation guide element 93 accesses to the memory card inserted in the card slot 41 via the memory card driver 122, and determines that the card has been changed when it is accessible.

In the case where the user has removed the transferring end memory card 40A but has not inserted the transferred end memory card 40B, the operation guide element 93 gives a warning (step S9). The warning can be displayed, for example, by a pop-up menu in the guide menu 97.

After giving the warning, if the process is not to be terminated (No in step S15), the flow may return to the state of step S7 for waiting a copy instructing operation. The user can resume the operation by making a copy instructing operation again after inserting the transferred end memory card 40B (step S7). If the process is to be terminated (Yes in step S15) after giving the warning, the remaining data in the RAM 113 that has been temporarily copied is cleared (step S16).

In step S8, if it is determined that the card has changed, the operation guide element 93 switches the display to the guide menu 97 in which “(3) FRAMES WILL BE COPIED TO THE CF CARD.” is highlighted as shown in FIG. 9C and causes the second transferring element 92 to work so as to transfer the data temporarily stored in the RAM 113 to the transferred end memory card 40B (step S10).

Next, whether the mode has been changed is determined (step S11), and if the mode has not been changed, the operation guide element 93 compares the size of data temporarily stored in the RAM 113 and the space area of the transferred end memory card 40B (step S12). If it is determined that the capacity of the transferred end memory card 40B is not enough, a warning is given (step S13). The warning can be displayed, for example, by a pop-up menu in the guide menu 97. The process for the case where it is determined that the mode has changed in step S11 will be described later.

Alternatively, it is also possible that the transferring process to the transferred end memory arc 40B is executed as far as possible by means of the second transferring element 92, and a warning is given at the point of time when the capacity of the transferred end memory card 40B becomes deficient.

After giving the warning, if the process is not to be terminated (No in step S15), the flow may return to the state of step S7 for waiting a copy instructing operation. The user can resume the operation by making a copy instructing operation again after inserting the transferred end memory card 40B (step S7). If the process is to be terminated (Yes in step S15) after giving the warning, the remaining data in the RAM 113 that has been temporarily copied is cleared (step S16).

In copying the data to the transferred end memory card 40B, the second transferring element 92 creates a folder 401 into which data is to be copied in the transferred end memory card 40B (shown in FIG. 6). Since the data is copied into the new folder 401 thus created, the problem that the data is overwritten can be solved even when data having the same file name as originally recorded on the transferred end memory card 40B.

In the case where the same file name exists, though a measure of asking for user's decision by displaying a message “OVERWRITE?” can be expected, this measure is troublesome in the case where a plurality of files exist because the message is displayed for each of the files. According to the present preferred embodiment, a merit that copying process of all of the files is executed without being interrupted.

If a folder having the same name as that of a folder to be created already exists in the transferred end memory card 40B, overwriting of the folder can be prevented by providing control of automatically changing the folder name and the like.

The copying with respect to the transferred end memory card 40B completes in response to the operation of the second transferring element 92, and as shown in FIG. 9D, the menu “COPYING HAS COMPLETED.” is highlighted in the guide menu 97 (step S14). Finally in step S16, data remaining in the RAM 113 that has been temporarily copied is cleared. Since a space area of the RAM 113 is secured by causing the erasing element 94 to operate at the time of interruption of the processing or completion of the processing, execution of other program will not be prevented by unnecessary data occupying the RAM 113.

Through the procedure as described above, data recorded on the transferring end memory card 40A is transferred to the transferred end memory card 40B via the RAM 113.

As described above, according to the present preferred embodiment, the user can conduct copying operation between memory cards by conducting the series of operations in accordance with the operation guide element 93. That is, the user can conduct copying operation with simple operation without consulting an instructional manual and the like for such a complicated operational procedure.

Furthermore, according to the present preferred embodiment, since the copying operation between memory cards is executed using only one card slot 41, the present invention is also applicable to a digital camera having only one card slot 41.

Furthermore, the present invention is applicable to a digital camera having a plurality of card slots as a matter of course, and the copying operation according to the present preferred embodiment enables copying between memory cards to be executed if at least one card slot is free among the plurality of card slots because only one card slot is used. For example, even in the case where other card such as USB card is inserted in other card slot, the copying operation can be executed in that state without removing the other card, which improves the operability.

Furthermore, in the digital camera 1 according to the present preferred embodiment, when the changeover slide switch 61 is switched to the photographing mode “REC” during the above-described series of copying operations in accordance with the operation guide element 93 (step S5 and step S11), the copying operation is terminated in accordance with the mode change. Then, the erasing element 94 is caused to operate to erase the data temporarily stored in the RAM 113 (step S16).

That is, in the case where a processing for forcefully terminate the transfer mode is made, in addition to the case where the mode is switched to the photographing mode “REC” by an operation of the changeover slide switch 61, the RAM 113 is released for other processings to be executed subsequently.

In this way, an enough space area of the RAM 113 is secured after interruption of the copying operation, thereby preventing the image processing of the photographed image from being affected.

Furthermore, in the present preferred embodiment, as the RAM 113 which temporarily records data in performing copying operation between memory cards, a volatile memory (e.g. DRAM) is adopted. Accordingly, when the power of the digital camera 1 is turned OFF, the data in the RAM 113 is cleared, so that even if some error occurs during copying operation between memory cards, the data temporarily recorded will not remain in the RAM 113 permanently. Therefore, even when the power is turned ON again, an influence will not exerted on the processing of photographed image.

While copying between memory cards is executed by menu selection in the regeneration mode in the digital camera according to the present preferred embodiment, copying between memory cards may be executed after switching the mode to a special mode by adding a transferring mode to the modes selectable by the changeover slide switch 61.

While the invention has been shown and described in detail, the foregoing description is in all aspects illustrative and not restrictive. It is therefore understood that numerous other modifications and variations can be devised without departing from the scope of the invention.

What is claimed is:

1. A digital camera comprising:
a slot to which a recording medium can be mounted;
a memory;
an operation guide generator for providing a guide about an operational procedure for executing a data processing including a first transferring process for transferring data recorded on a recording medium mounted to said slot to said memory and a second transferring process for transferring data recorded in said memory to a recording medium mounted to said slot;
an operational member which is operable by an operator; and
a controller for executing said data processing in response to an operation to said operational member in accordance with a guide provided by said operation guide generator.

2. The digital camera according to claim 1 further comprising:
a display,
wherein said operation guide generator displays operational contents on said display.

3. The digital camera according to claim 1,
wherein said operation guide generator guides to change the recording medium in said slot after completion of said first transferring process.

4. The digital camera according to claim 1,
wherein said operation guide generator gives a warning if an instruction for starting said second transferring process is made by said operational member after completion of said first transferring process and in the condition that a recording medium within said slot has not been changed.

5. The digital camera according to claim 1,
wherein said controller creates a new data storage block in the recording medium mounted to said slot and transfers the data to the created data storage block before the execution of said second transferring process.

6. The digital camera according to claim 1,
wherein said operation guide generator gives a warning when the capacity of the recording medium is deficient due to execution of said second transferring process or when it is determined that the capacity of the recording medium will be deficient.

7. The digital camera according to claim 1,
wherein said memory is a volatile memory.

8. The digital camera according to claim 1,
wherein said controller erases the data stored in said memory by said first transferring process after said second transferring process has completed.

9. The digital camera according to claim 1,
wherein said controller can executes while switching between a first mode which enables photographing operation and a second mode which enables said data processing, and erases the data stored in said memory by said first transferring process when the mode is switched from said second mode to said first mode.

10. A digital camera comprising:
a slot to which a recording medium can be mounted;
a volatile memory; and
a controller for executing a data processing including a first transferring process for transferring data recorded on a recording medium mounted to said slot to said memory and a second transferring process for transferring data recorded in said memory to a recording medium mounted to said slot.

11. A digital camera comprising:
a slot to which a recording medium can be mounted;
a memory; and
a controller for executing a data processing including a first transferring process for transferring data recorded on a recording medium mounted to said slot to said memory, a second transferring process for transferring data recorded in said memory to a recording medium mounted to said slot, and a process executed after completion of the second transferring process, for erasing the data stored in said memory by said first transferring process.

12. A data processing method of digital camera comprising the steps of:
transferring data recorded on a recording medium mounted to a slot to a memory;
providing a guide for urging change of the recording medium mounted to said slot; and
transferring the data recorded in said memory to a recording medium mounted to said slot.
